(19) United States
(12) Patent Application Publication
(10) Pub. No.: US 2009/0080956 A1
(43) Pub. Date: Mar. 26, 2009

(54) IN-LINE PRINTING MEDIA TREATMENT FOR PRINTING ON NON-PAPER PRINTING MEDIA AND THICK PRINTING MEDIA

(76) Inventors: David B. Montfort, Webster, NY (US); Michael A. Fayette, Penfield, NY (US); William G. Osbourne, Webster, NY (US)

Correspondence Address: Gibb Intellectual Property Firm, LLC, 2568-A Riva Road Suite 304, Annapolis, MD, 21401, US

(21) Appl. No.: 11/861,356

(22) Filed: Sep. 26, 2007

(51) Int. Cl. G03G 15/00

(52) U.S. Cl. 399/390

(57) ABSTRACT

A method and printing device positions a conductive film applicator adjacent a printing media transport within a printing device. The conductive film applicator is positioned between the printing media input and the marking station. As the printing media moves by the conductive film applicator, the conductive film applicator applies a conductive film to the printing media. After the conductive film has been applied to the printing media, the printing media is moved to the marking station and printing operations are performed on the printing media. After printing is complete, the printing media can be output from the printing device.

### BACKGROUND AND SUMMARY

Embodiments herein generally relate to systems, methods, services, etc., for reducing printing errors that occur on non-paper printing media and thick printing media, that utilizes an anti-static coating or anti-static wipe that is applied to the printing media prior to the printing media entering the marking station.

Embodiments herein utilize a device that includes the ability to print and which may also be able to scan; perform processing on documents; communicate with remote entities; etc. There are many devices currently available that have these abilities, such as copiers, fax machines, multifunction printers, etc., and the embodiments herein are intended to operate with all such machines, as well as other devices. For example, Xerox Corporation, Stamford Conn., USA, manufactures many copying and printing devices that have the ability to print, scan, fax, process documents, and communicate over wired and wireless syndication networks. The detailed workings of such devices are not elaborated upon in detail herein, so as to focus the reader on the salient aspects of the present embodiments.

Such printing and copying devices are used by a wide variety of customers who have vastly differing needs and expectations of the printing device. Customers are constantly stretching the limits with regard to what substrates they would like to be able to print on. End users often desire to print on different materials, such as woods, metals, alloys, plastics, glasses, ceramics, cloths, etc., any of which can have varying thicknesses and surface treatments. For example, plastics, such as thick credit-card sized pieces of plastic or plastic transparencies (thin sheets of transparent plastic) are common items subjected to printing. However, printing on such thick or non-paper type printing media often results in poor print quality, with many printing defects and errors.

The embodiments herein provide various methods and devices where a conductive film applicator is positioned adjacent a printing media transport within a printing device. The printing media transport moves the printing media from the printing media input to the marking station of the printing device.

The conductive film applicator is positioned between the printing media input and the marking station. As the printing media moves by the conductive film applicator, the methods and devices herein apply a conductive film to the printing media using the conductive film applicator. After the conductive film has been applied to the printing media, the methods and apparatus herein move the printing media to the marking station and perform printing operations on the printing media using the marking station. After printing is complete, the printing media can be output from the printing device.

In some embodiments, the conductive film applicator comprises a contact applicator and the application of the conductive film comprises physically contacting the printing media to deposit a conductive anti-static liquid on the printing media. In other embodiments, the conductive film applicator comprises a sprayer and the application of the conductive film comprises spraying a conductive anti-static liquid on the printing media.

In embodiments herein, when applying the conductive film, the characteristics of application of the conductive film are precisely controlled by the conductive film applicator, depending upon characteristics of the printing that will be performed on the printing media by the marking station. For example, the embodiments herein vary the application of the conductive film depending upon the material makeup of the printing media, the thickness of the printing media, the type of marking material (e.g., ink, toner, etc.) that will be utilized by the marking station and/or the types of marks that will be made by the marking station.

An apparatus embodiment herein (e.g., a printing device) can comprise an entire printing device or simply a module within a printing device and can include a printing media transport that moves the printing media within the apparatus, a printing media input positioned at the first end of the printing media transport, and a printing media output position at the second end of the printing media transport. A marking station is positioned within the apparatus adjacent to the printing media transport and between the first and second ends of the printing media transport. The marking station is adapted to form print markings on the printing media.

In some embodiments, a conductive film applicator is positioned adjacent the printing media transport, and positioned between the printing media input and the marking station. In other embodiments, an anti-static wipe is positioned adjacent the printing media transport and between the printing media input and the marking station.

The conductive film applicator is adapted to apply a conductive film to the printing media as the printing media is supplied to the marking station. The conductive film applicator can comprise a contact applicator adapted to physically contact the printing media and to deposit a conductive liquid on the printing media when applying the conductive film to the printing media. Alternatively, the conductive film applicator can comprise a sprayer adapted to spray a conductive liquid on the printing media when applying the conductive film to the printing media.

The anti-static wipe draws or removes static electronic charges from the printing media as the printing media is supplied to the marking station. The anti-static wipe can comprise a conductive pad adapted to physically contact the printing media to remove charges from the printing media. Alternatively, the anti-static wipe can comprise a non-contact element adapted to draw charges from the printing media.

In any of the foregoing embodiments, the module and/or printing device can include a controller operatively connected to the conductive film applicator (or the anti-static wipe). The controller is adapted to control characteristics of application of the conductive film by the conductive film applicator (or operations of the anti-static wipe) depending upon characteristics of printing operations that will be performed on the printing media by the marking station. Such characteristics of application of the conductive film (or operations of the anti-static wipe) are varied by the controller depending upon items such as the material makeup of the printing media, the thickness of the printing media, the type of marking material that will be utilized by the marking station, types of marks that will be made by the marking station, etc.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a schematic representation of an apparatus embodiment herein;

FIG. 2 is a schematic representation of an apparatus embodiment herein;

FIG. 3 is a schematic representation of an apparatus embodiment herein;

FIG. 4 is a schematic representation of an apparatus embodiment herein;

FIG. 5 is a flow diagram illustrating embodiments herein; and

FIG. 6 is a schematic representation of an apparatus embodiment herein.

### DETAILED DESCRIPTION

As discussed above, embodiments herein provide systems and methods for reducing printing errors that occur on non-paper printing media and thick printing media, that utilize an anti-static coating or anti-static wipe that is applied to the printing media prior to the printing media entering the marking station.

As also mentioned above, customers are constantly stretching the limits with regard to what substrates they would like to be able to print on. End users often desire to print on different materials, such as woods, metals, alloys, plastics, cloth, etc., any of which can have varying thicknesses and surface treatments. For example, plastics, such as thick (e.g., greater than 0.5 mm) credit-card sized pieces of plastic or plastic transparencies (thin (e.g., less than 0.5 mm) sheets of transparent plastic) are common items subjected to printing. Such plastics are commonly surface treated for optimal printing transfer performance when they are manufactured. Thus, in some situations, transparencies are surface finish coated with a conductive or semi-conductive film. Some aspect of transparencies and associated technology is provided in U.S. Pat. Nos. 3,949,148 and 5,104,721 (the complete disclosures of which are incorporated herein by reference) and a detailed discussion of such topics is omitted herefrom to focus the reader on the salient portions of the embodiments herein. The amount of conductivity provided during the manufacturing of plastic transparencies is established at the time of manufacture and may not be precisely the amount of conductivity needed in a specific printing situation. To the contrary, with the embodiments described herein, the amount of conductivity existing on the surface of the printing media is adjusted precisely immediately before the printing media is supplied to the marking station to reduce printing errors.

If a substrate surface is not coated (or not properly coated) prior to printing, severe transfer defects can result. Such printing defects include very poor transfer efficiency, streaks, mottle, stars, and general blotchy toner redistribution. The present embodiments coat the surface of print media (or adjust the amount of charge on the printing media) automatically as the machine is printing, thereby offering a much wider array of capabilities. This eliminates the need for the customer to have to maintain quantities of specially treated supplies of media, each of which may only be used in very specialized, limited application situations.

Thus, as discussed above, when utilizing non-paper print media (such as, metals, alloys, woods, plastics, glasses, ceramics, cloths, etc.) or when utilizing very thick print media, the printed marks can be riddled with image quality defects. During testing performed by the present inventors, such defects were isolated to “transfer created” artifacts. The present inventors determined that these transfer created defects were related to surface problems with conductivity parameters of the printing media.

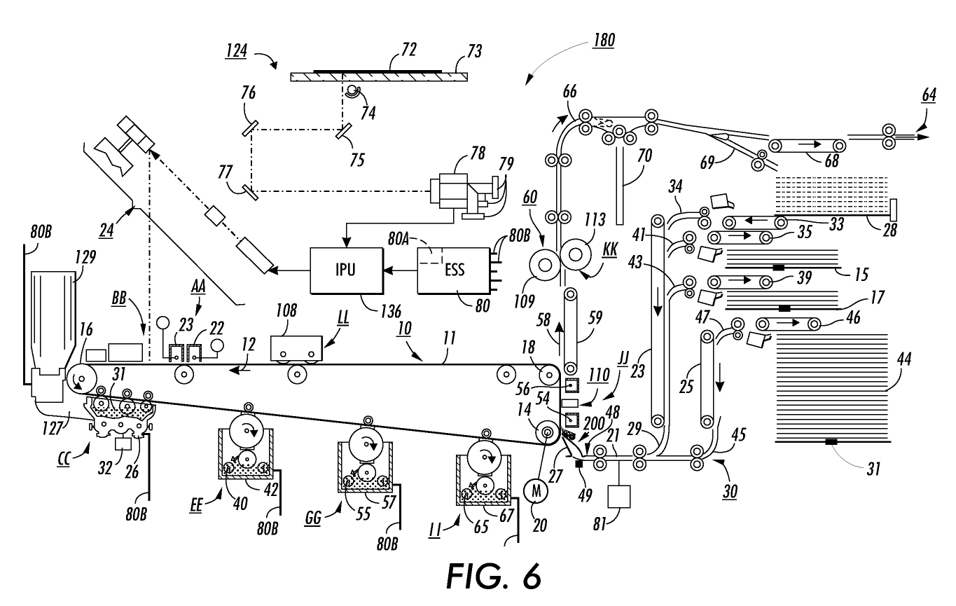

As discussed above, embodiments herein utilize a device that includes the ability to print and which may also be able to scan, perform processing on documents, communicate with remote entities, etc. There are many devices currently available that have these abilities, such as copiers, fax machines, multifunction printers, etc., and the embodiments herein are intended to operate with all such machines as well as other devices. The term “printing device” as used herein encompasses any such digital copier, bookmaking machine, facsimile machine, multi-function machine, etc., which performs a scanning and print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. Printers are readily available devices produced by manufactures such as Xerox Corporation, Stamford, Conn., USA. Such printers commonly include input/output, power supplies, processors, media movement devices, marking devices etc., the details of which are omitted herefrom to allow the reader to focus on the salient aspects of the embodiments described herein. FIG. 6 illustrates an exemplary device in which the module embodiments herein operate with high effectiveness.

More specifically, FIG. 6 illustrates an exemplary electrostatographic reproduction machine, for example, a multipass color electrostatographic reproduction machine 180. As is well known, the color copy process typically involves a computer generated color image which may be conveyed to an image processor 136, or alternatively a color document 72 which may be placed on the surface of a transparent platen 73. A scanning assembly 124, having a light source 74 illuminates the color document 72. The light reflected from document 72 is reflected by mirrors 75, 76, and 77, through lenses (not shown) and a dichroic prism 78 to three charged-coupled linear photosensing devices (CCDs) 79 where the information is read. Each CCD 79 outputs a digital image signal the level of which is proportional to the intensity of the incident light. The digital signals represent each pixel and are indicative of blue, green, and red densities. They are conveyed to the IPU 136 where they are converted into color separations and bit maps, typically representing yellow, cyan, magenta, and black. IPU 136 stores the bit maps for further instructions from an electronic subsystem (ESS) 80.

The ESS is preferably a self-contained, dedicated mini-computer having a central processor unit (CPU), electronic storage, and a display or graphic user interface (GUI). The ESS is the control system which, with the help of sensors, and connections 80B as well as a pixel counter 80A, reads, captures, prepares and manages the image data flow between IPU 136 and image input terminal 124. In addition, the ESS 80 is the main multi-tasking processor for operating and controlling all of the other machine subsystems and printing operations. These printing operations include imaging, development, sheet delivery and transfer, and particularly control of the sequential transfer assist blade assembly. Such operations also include various functions associated with subsequent finishing processes. Some or all of these subsystems may have micro-controllers that communicate with the ESS 80.

The multipass color electrostatographic reproduction machine 180 employs a photoreceptor 10 in the form of a belt having a photoconductive surface layer 11 on an electroconductive substrate. The surface 11 can be made from an organic photoconductive material, although numerous photoconductive surfaces and conductive substrates may be employed. The belt 10 is driven by means of motor 20 having an encoder attached thereto (not shown) to generate a machine timing clock. Photoreceptor 10 moves along a path defined by rollers 14, 18, and 16 in a counter-clockwise direction as shown by arrow 12.

Initially, in a first imaging pass, the photoreceptor 10 passes through charging station AA where a corona generating devices, indicated generally by the reference numeral 22, 23, on the first pass, charge photoreceptor 10 to a relatively high, substantially uniform potential. Next, in this first imaging pass, the charged portion of photoreceptor 10 is advanced through an imaging station BB. At imaging station BB, the uniformly charged belt 10 is exposed to the scanning device 24 forming a latent image by causing the photoreceptor to be discharged in accordance with one of the color separations and bit map outputs from the scanning device 24, for example black. The scanning device 24 is a laser Raster Output Scanner (ROS). The ROS creates the first color separatism image in a series of parallel scan lines having a certain resolution, generally referred to as lines per inch. Scanning device 24 may include a laser with rotating polygon mirror blocks and a suitable modulator, or in lieu thereof, a light emitting diode array (LED) write bar positioned adjacent the photoreceptor 10.

At a first development station CC, a non-interactive development unit, indicated generally by the reference numeral 26, advances developer material 31 containing carrier particles and charged toner particles at a desired and controlled concentration into contact with a donor roll, and the donor roll then advances charged toner particles into contact with the latent image and any latent target marks. Development unit 26 may have a plurality of magnetic brush and donor roller members, plus rotating augers or other means for mixing toner and developer. These donor roller members transport negatively charged black toner particles for example, to the latent image for development thereof which tones the particular (first) color separation image areas and leaves other areas untoned. Power supply 32 electrically biases development unit 26. Development or application of the charged toner particles as above typically depletes the level and hence concentration of toner particles, at some rate, from developer material in the development unit 26. This is also true of the other development units (to be described below) of the machine 180.

On the second and subsequent passes of the multipass machine 180, the pair of corona devices 22 and 23 are employed for recharging and adjusting the voltage level of both the toned (from the previous imaging pass), and untoned areas on photoreceptor 10 to a substantially uniform level. A power supply is coupled to each of the electrodes of corona recharge devices 22 and 23. Recharging devices 22 and 23 substantially eliminate any voltage difference between toned areas and bare untoned areas, as well as to reduce the level of residual charge remaining on the previously toned areas, so that subsequent development of different color separation toner images is effected across a uniform development field.

Imaging device 24 is then used on the second and subsequent passes of the multipass machine 180, to superimpose subsequent a latent image of a particular color separation image, by selectively discharging the recharged photoreceptor 10. The operation of imaging device 24 is of course controlled by the controller, ESS 80. One skilled in the art will recognize that those areas developed or previously toned with black toner particles will not be subjected to sufficient light from the imaging device 24 as to discharge the photoreceptor region lying below such black toner particles. However, this is of no concern as there is little likelihood of a need to deposit other colors over the black regions or toned areas.

Thus on a second pass, imaging device 24 records a second electrostatic latent image on recharged photoreceptor 10. Of the four development units, only the second development unit 42, disposed at a second developer station EE, has its development function turned “on” (and the rest turned “off”) for developing or toning this second latent image. As shown, the second development unit 42 contains negatively charged developer material 40, for example, one including yellow toner. The toner 40 contained in the development unit 42 is thus transported by a donor roll to the second latent image recorded on the photoreceptor 10, thus forming additional toned areas of the particular color separation on the photoreceptor 10. A power supply (not shown) electrically biases the development unit 42 to develop this second latent image with the negatively charged yellow toner particles 40. As will be further appreciated by those skilled in the art, the yellow colorant is deposited immediately subsequent to the black so that further colors that are additive to yellow, and interact therewith to produce the available color gamut, can be exposed through the yellow toner layer.

On the third pass of the multipass machine 180, the pair of corona recharge devices 22 and 23 are again employed for recharging and readjusting the voltage level of both the toned and untoned areas on photoreceptor 10 to a substantially uniform level. A power supply is coupled to each of the electrodes of corona recharge devices 22 and 23. The recharging devices 22 and 23 substantially eliminate any voltage difference between toned areas and bare untoned areas, as well as to reduce the level of residual charge remaining on the previously toned areas so that subsequent development of different color toner images is effected across a uniform development field. A third latent image is then again recorded on photoreceptor 10 by imaging device 24. With the development functions of the other development units turned “off”, this image is developed in the same manner as above using a third color toner 55 contained in a development unit 57 disposed at a third developer station GG. An example of a suitable third color toner is magenta. Suitable electrical biasing of the development unit 57 is provided by a power supply, not shown.

On the fourth pass of the multipass machine 180, the pair of corona recharge devices 22 and 23 again recharge and adjust the voltage level of both the previously toned and yet untoned areas on photoreceptor 10 to a substantially uniform level. A power supply is coupled to each of the electrodes of corona recharge devices 22 and 23. The recharging devices 22 and 23 substantially eliminate any voltage difference between toned areas and bare untoned areas as well as to reduce the level of residual charge remaining on the previously toned areas. A fourth latent image is then again created using imaging device 24. The fourth latent image is formed on both bare areas and previously toned areas of photoreceptor 10 that are to be developed with the fourth color image. This image is developed in the same manner as above using, for example, a cyan color toner 65 contained in development unit 67 at a fourth developer station II. Suitable electrical biasing of the development unit 67 is provided by a power supply, not shown.

Following the black development unit 26, development units 42, 57, and 67 are preferably of the type known in the art which do not interact, or are only marginally interactive with previously developed images. For examples, a DC jumping development system, a powder cloud development system, or a sparse, non-contacting magnetic brush development system are each suitable for use in an image on image color development system as described herein. In order to condition the toner for effective transfer to a substrate, a negative pre-transfer corotron member negatively charges all toner particles to the required negative polarity to ensure proper subsequent transfer.

Since the machine 180 is a multicolor, multipass machine as described above, only one of the plurality of development units, 26, 42, 57 and 67 may have its development function turned “on” and operating during any one of the required number of passes, for a particular color separation image development. The remaining development units thus have their development functions turned off.

During the exposure and development of the last color separation image, for example by the fourth development unit 65, 67 a sheet of support material is advanced to a transfer station JJ by a sheet feeding apparatus 30. During simplex operation (single sided copy), a blank sheet may be fed from tray 15 or tray 17, or a high capacity tray 44 could thereunder, to a registration transport 21, in communication with controller 81, where the sheet is registered in the process and lateral directions, and for skew position. As shown, the tray 44 and each of the other sheet supply sources includes a sheet size sensor 31 that is connected to the controller 80. One skilled in the art will realize that trays 15, 17, and 44 each hold a different sheet type.

The speed of the sheet is adjusted at registration transport 21 so that the sheet arrives at transfer station JJ in synchronization with the composite multicolor image on the surface of photoconductive belt 10. Registration transport 21 receives a sheet from either a vertical transport 23 or a high capacity tray transport 25 and moves the received sheet to pretransfer baffles 27. The vertical transport 23 receives the sheet from either tray 15 or tray 17, or the single-sided copy from duplex tray 28, and guides it to the registration transport 21 via a turn baffle 29. Sheet feeders 35 and 39 respectively advance a copy sheet from trays 15 and 17 to the vertical transport 23 by chutes 41 and 43. The high capacity tray transport 25 receives the sheet from tray 44 and guides it to the registration transport 21 via a lower baffle 45. A sheet feeder 46 advances copy sheets SS from tray 44 to transport 25 by a chute 47.

As shown, pretransfer baffles 27 and 48 guide the sheet from the registration transport 21 to transfer station JJ. Charge can be placed on the baffles from either the movement of the sheet through the baffles or by the corona generating devices 54, 56 located at marking station or transfer station JJ.

Transfer station JJ includes a transfer corona device 54 which provides positive ions to the backside of the copy sheet. This attracts the negatively charged toner powder images from photoreceptor belt 10 to the sheet. A detack corona device 56 is provided for facilitating stripping of the sheet from belt 10. A sheet-to-image registration detector 110 is located in the gap between the transfer and corona devices 54 and 56 to sense variations in actual sheet to image registration and provides signals indicative thereof to ESS 80 and controller 81 while the sheet is still tacked to photoreceptor belt 10.

The transfer station JJ also includes the transfer assist blade assembly 200, in which various segmented blades are engaged for contacting the backside of the image receiving sheet. After transfer, the sheet continues to move, in the direction of arrow 58, onto a conveyor 59 that advances the sheet to fusing station KK.

Fusing station KK includes a fuser assembly, indicated generally by the reference numeral 60, which permanently fixes the transferred color image to the copy sheet. Preferably, fuser assembly 60 comprises a heated fuser roller 109 and a backup or pressure roller 113. The copy sheet passes between fuser roller 109 and backup roller 113 with the toner powder image contacting fuser roller 109. In this manner, the multi-color toner powder image is permanently fixed to the sheet. After fusing, chute 66 guides the advancing sheet to feeder 68 for exit to a finishing module (not shown) via output 64. However, for duplex operation, the sheet is reversed in position at inverter 70 and transported to duplex tray 28 via chute 69. Duplex tray 28 temporarily collects the sheet whereby sheet feeder 33 then advances it to the vertical transport 23 via chute 34. The sheet fed from duplex tray 28 receives an image on the second side thereof, at transfer station JJ, in the same manner as the image was deposited on the first side thereof. The completed duplex copy exits to the finishing module (not shown) via output 64.

After the sheet of support material is separated from photoreceptor 10, the residual toner carried on the photoreceptor surface is removed therefrom. The toner is removed for example at cleaning station LL using a cleaning brush structure contained in a unit 108.

Therefore, embodiments herein can include a printing media transport 30 that moves the printing media within the apparatus, a printing media input 44 positioned at the first end of the printing media transport, and a printing media output 64 position at the second end of the printing media transport. A marking station JJ is positioned within the apparatus adjacent to the printing media transport and between the first and second ends of the printing media transport. The marking station is adapted to form print markings on the printing media.

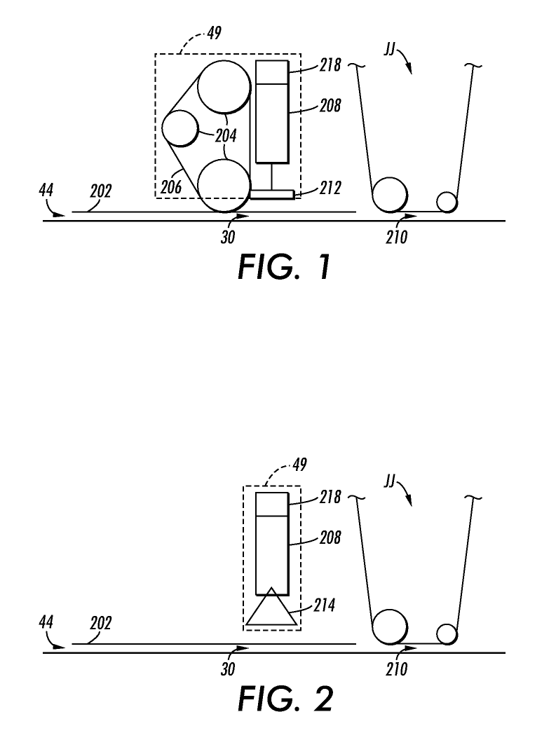

Thus, an apparatus embodiment herein (e.g., a printing device) can comprise an entire printing device (such as that shown in FIG. 6) or can simply comprise an in-line printing media treatment module 49 within such a printing device. The in-line printing media treatment module 49 is illustrated in greater detail in FIGS. 1-4.

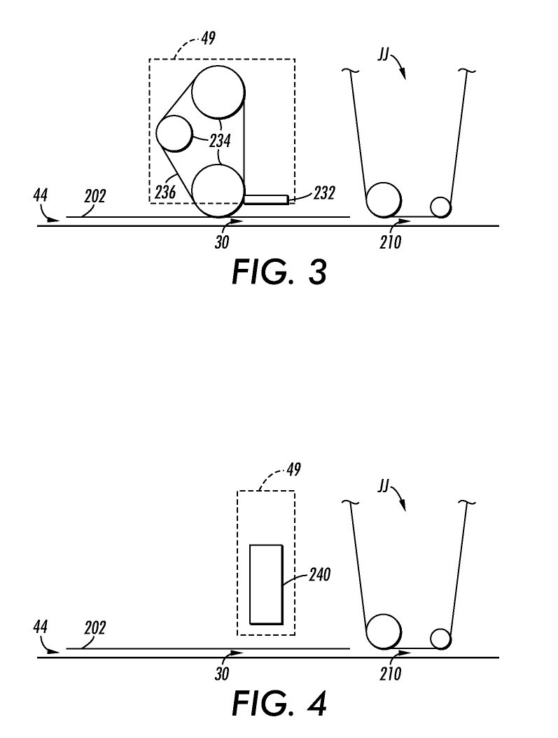

Referring to FIGS. 1 and 2, in some embodiments the in-line printing media treatment module 49 comprises a conductive film applicator that is positioned adjacent the printing media transport 30, and positioned between the printing media input 44 and the transfer region 210 of the marking station JJ. In other embodiments illustrated in FIGS. 3 and 4, the in-line printing media treatment module 49 takes the form of an anti-static wipe positioned adjacent the printing media transport 30 and between the printing media input 44 and the marking station JJ.

The conductive film applicator shown in FIGS. 1 and 2 is adapted to apply a conductive film to the printing media 202 as the printing media 202 is supplied to the marking station. The conductive film applicator can comprise a contact applicator 206 (such as a belt of absorptive material supported by at least one driven roller 204) that is adapted to physically contact the printing media 202 so as to deposit a conductive liquid 218 (maintained within a reservoir 208) on the printing media 202 when applying the conductive film to the printing media 202.

More specifically, as illustrated in FIG. 1, as the belt of absorptive material 206 passes by the lower opening of the reservoir 208, the belt 206 becomes moistened with the conductive liquid 218 maintained within the reservoir 208. The belt 206 can comprise, for example, a cloth (natural or synthetic), which has some absorption capability, or any other appropriate material. The conductive liquid comprises any anti-static fluid. Static removal fluids, belts and other systems are discussed in detail in U.S. Pat. Nos. 3,790,854; 5,072,243; 5,913,335; and French Patent 2,728,081 (the complete disclosures of which are incorporated herein by reference) and a detailed discussion of such topics is omitted herefrom to focus the reader on the salient portions of the embodiments herein.

When the belt 206 contacts the printing media 202, the conductive liquid 218 is transferred from the belt 206 to the printing media 202. Note that the in-line printing media treatment module 49 is connected to a controller (such as any of the controllers 80, 81, etc., mentioned above) which can control the rotational rate of the rollers 204 as well as a flow control valve 212 within the reservoir 208 to control the amount of conductive liquid 218 that is applied (and the rate at which the conductive liquid 218 is applied) to the printing media 202.

Alternatively, as illustrated in FIG. 2, the conductive film applicator can comprise a sprayer 214 adapted to spray the conductive liquid 218 on the printing media 202 when applying the conductive film to the printing media 202. Similarly to the embodiment shown in FIG. 1, a controller (such as any of the controllers 80, 81, etc., mentioned above) can control the rate of flow from the sprayer 214 to control the amount of conductive liquid 218 that is applied (and the rate at which the conductive liquid 218 is applied) to the printing media 202.

As mentioned above, FIGS. 3 and 4 illustrate embodiments where the in-line printing media treatment module 49 takes the form of an anti-static wipe or swipe. The anti-static wipe draws or removes static electronic charges from the printing media 202 as the printing media 202 is supplied to the marking station JJ.

The anti-static wipe can comprise a conductive pad 236 adapted to physically contact the printing media 202 to remove charges from the printing media 202, as shown in FIG. 3. Elements of removal of static charges using contact devices is disclosed in, for example, U.S. Patent Publication 2007/171592 and U.S. Pat. Nos. 6,367,115 and 7,080,835 (the complete disclosures of which are incorporated herein by reference) and a detailed discussion of such topics is omitted herefrom to focus the reader on the salient portions of the embodiments herein. The conductive pad 236 can be supported by rollers 234 (at least one of which is driven). The conductive pad 236 passes element 232, which can comprise any number of devices (such as a container of anti-static fluid, an ion generator, inductor, capacitor, corona discharge device, etc.) that have the ability to place or remove charges from the conductive pad 236. For a complete discussion of ionizers see U.S. Patent Publication 2006/158819 and U.S. Pat. No. 5,402,304 (the complete disclosures of which are incorporated herein by reference) and a detailed discussion of such topics is omitted herefrom to focus the reader on the salient portions of the embodiments herein.

Similarly to the previous embodiments shown above, a controller (such as any of the controllers 80, 81, etc., mentioned above) can control the rate at which the conductive pad 236 moves across the printing media 202, as well as the amount of charges that are added or removed from the conductive pad 236 by the element 232 to control the amount of charge that is applied and/or removed to or from the printing media 202.

Alternatively, the anti-static wipe can comprise a non-contact element 240 adapted to electrostatically draw charges from or place charges on the printing media 202, as illustrated in FIG. 4. Element 204 can comprise any item, such as the ion generator, inductor, capacitor, corona discharge device, etc. mentioned above. Again, a controller (such as any of the controllers 80, 81, etc., mentioned above) can control the amount of charges that are added or removed from the printing media 202.

Thus, as shown above, the module 49 and/or printing device (FIG. 6) can include a controller 80, 81 operatively connected to the conductive film applicator (or the anti-static wipe). The controller is adapted to control characteristics of application of the conductive film by the conductive film applicator (or operations of the anti-static wipe) depending upon characteristics of printing operations that will be performed on the printing media by the marking station. Such characteristics of application of the conductive film (or operations of the anti-static wipe) are varied by the controller depending upon items such as the material makeup of the printing media, the thickness of the printing media, the type of marking material that will be utilized by the marking station, types of marks that will be made by the marking station, etc.

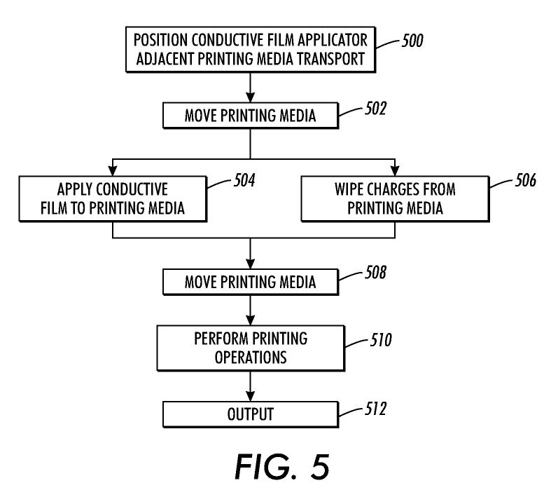

FIG. 5 is a flowchart illustrating method embodiments herein where a conductive film applicator is positioned adjacent a printing media transport within a printing device in item 500. In item 500, the conductive film applicator is positioned between the printing media input and the marking station. In item 502, the printing media transport moves the printing media from the printing media input to the marking station of the printing device, allowing the printing media to pass by the conductive film applicator (module 49).

As the printing media moves by the conductive film applicator, the methods and devices herein apply a conductive film to the printing media using the conductive film applicator in item 504 or the method wipes charges from the printing media in item 506. After the conductive film has been applied to the printing media (or charges have been wiped), the methods and apparatus herein move the printing media to the marking station (item 508) and perform printing operations on the printing media using the marking station (item 510). After printing is complete, the printing media can be output from the printing device in item 512.

Therefore, the present embodiments were developed to deposit a conductive coating or film on the outer surface of the printing media (or adjust the amount of charge on the printing media) just before the media enters the transfer station of the printing engine, so as to precisely establish the amount of conductivity on the printing side of the surface of the print media that is appropriate for the type of printing that the transfer station will apply to the printing media. Treating the printing media with a conductive film prior to transfer reduces the charge (and field) non-uniformities that lead to printing errors.

For example, the printing media can be given a quick spray or wipe with an anti-static fluid (conductive fluid) or pad before being supplied to the printing engine. The present embodiments provide a subsystem or module that, when operated through software activated by input to the graphical user interface of the printer (e.g., the ESS 80 discussed above), preconditions the printing media, on the fly, prior to entering the marking material transfer zone of the printing engine.

In some embodiments, this subsystem comprises a retracting web type device (similar to a fluid bearing web cleaner) or can comprise an ultrasonic mister which applies the conductive fluid on the passing sheets of print media, as shown in FIGS. 1 and 2, above. In addition, the application of a conductive fluid or film is not a requirement of embodiments herein, as different embodiments herein treat the web of printing media using anti-static sheets, as shown in FIG. 3.

All foregoing embodiments are specifically applicable to electrostatographic and/or xerographic machines and/or processes as well as to software programs stored on the electronic memory 80 (computer usable data carrier) and to services whereby the foregoing methods are provided to others for a service fee. It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof.

What is claimed is:

1. A module for use within a printing device, said module comprising:
a conductive film applicator,
wherein said conductive film applicator is adapted to be positioned adjacent a printing media transport that is adapted to move printing media from a printing media input of said printing device to a marking station of said printing device,
wherein said conductive film applicator is further adapted to be positioned between said printing media input and said marking station, and
wherein said conductive film applicator is further adapted to apply a conductive film to said printing media as said printing media is supplied to said marking station.

2. The module according to claim 1, all the limitations of which are incorporated herein by reference, wherein said conductive film applicator comprises a contact applicator adapted to physically contact said printing media and to deposit a conductive liquid on said printing media so as to apply said conductive film to said printing media.

3. The module according to claim 1, all the limitations of which are incorporated herein by reference, wherein said conductive film applicator comprises a sprayer adapted to spray a conductive liquid on said printing media so as to apply said conductive film to said printing media.

4. The module according to claim 1, all the limitations of which are incorporated herein by reference, further comprising a controller operatively connected to said conductive film applicator, wherein said controller is adapted to control characteristics of application of said conductive film by said conductive film applicator depending upon characteristics of printing operations that will be performed on said printing media by said marking station.

5. The module according to claim 4, all the limitations of which are incorporated herein by reference, wherein said characteristics of application of said conductive film are varied by said controller depending upon at least one of: a material makeup of said printing media; a thickness of said printing media; a type of marking material utilized by said marking station; and types of marks made by said marking station.

6. A printing device comprising:
a printing media transport adapted to move printing media within said apparatus;
a printing media input positioned at a first end of said printing media transport;
a printing media output position at a second end of said printing media transport;
a marking station positioned within said apparatus adjacent to said printing media transport, wherein said marking station is adapted to form print markings on said printing media; and
a conductive film applicator positioned adjacent said printing media transport, and positioned between said printing media input and said marking station, wherein said conductive film applicator is adapted to apply a conductive film to said printing media as said printing media is supplied to said marking station.

7. The printing device according to claim 6, all the limitations of which are incorporated herein by reference, wherein said conductive film applicator comprises a contact applicator adapted to physically contact said printing media and to deposit a conductive liquid on said printing media so as to apply said conductive film to said printing media.

8. The printing device according to claim 6, all the limitations of which are incorporated herein by reference, wherein said conductive film applicator comprises a sprayer adapted to spray a conductive liquid on said printing media so as to apply said conductive film to said printing media.

9. The printing device according to claim 6, all the limitations of which are incorporated herein by reference, further comprising a controller operatively connected to said conductive film applicator, wherein said controller is adapted to control characteristics of application of said conductive film by said conductive film applicator depending upon characteristics of printing operations that will be performed on said printing media by said marking station.

10. The printing device according to claim 9, all the limitations of which are incorporated herein by reference, wherein said characteristics of application of said conductive film are varied by said controller depending upon at least one of: a material makeup of said printing media; a thickness of said printing media; a type of marking material utilized by said marking station; and types of marks made by said marking station.

11. A module for use within a printing device, said module comprising:
an anti-static wipe,
wherein said anti-static wipe is adapted to be positioned adjacent a printing media transport that is adapted to move printing media from a printing media input of said printing device to a marking station of said printing device,
wherein said anti-static wipe is further adapted to be positioned between said printing media input and said marking station, and
wherein said anti-static wipe is further adapted to wipe static electronic charges from said printing media as said printing media is supplied to said marking station.

12. The module according to claim 11, all the limitations of which are incorporated herein by reference, wherein said anti-static wipe comprises a conductive pad adapted to physically contact said printing media and to remove charges from said printing media.

13. The module according to claim 11, all the limitations of which are incorporated herein by reference, wherein said anti-static wipe comprises a non-contact electrostatic element adapted to electrostatically draw charges from said printing media.

14. The module according to claim 11, all the limitations of which are incorporated herein by reference, further comprising a controller operatively connected to said anti-static wipe, wherein said controller is adapted to control characteristics of operation of said anti-static wipe depending upon characteristics of printing operations that will be performed on said printing media by said marking station.

15. The module according to claim 14, all the limitations of which are incorporated herein by reference, wherein said printing device comprises one of an electrostatographic device and a xerographic device.

16. A method comprising:
positioning a conductive film applicator adjacent a printing media transport that is adapted to move printing media from a printing media input of a printing device to a marking station of said printing device, such that said conductive film applicator is positioned between said printing media input and said marking station;
moving said printing media by said conductive film applicator;
applying a conductive film to said printing media using said conductive film applicator as said printing media moves by said conductive film applicator;
after said conductive film has been applied to said printing media, moving said printing media to said marking station;
printing on said printing media using said marking station; and
outputting said printing media from said printing device.

17. The method according to claim 16, all the limitations of which are incorporated herein by reference, wherein said conductive film applicator comprises a contact applicator, and
wherein said applying of said conductive film comprises physically contacting said printing media to deposit a conductive liquid on said printing media.

18. The method according to claim 16, all the limitations of which are incorporated herein by reference, wherein said conductive film applicator comprises a sprayer, and
wherein said applying of said conductive film comprises spraying a conductive liquid on said printing media.

19. The method according to claim 16, all the limitations of which are incorporated herein by reference, wherein said applying of said conductive film comprises controlling characteristics of application of said conductive film by said conductive film applicator depending upon characteristics of said printing that will be performed on said printing media by said marking station.

20. The method according to claim 19, all the limitations of which are incorporated herein by reference, wherein said controlling of said characteristics comprises varying said application of said conductive film depending upon at least one of: a material makeup of said printing media; a thickness of said printing media; a type of marking material utilized by said marking station; and types of marks made by said marking station.
